(19) United States
(12) Patent Application Publication
(10) Pub. No.: US 2026/0185646 A1
(43) Pub. Date: Jul. 2, 2026

(54) Pipe Shield With Flexible Mounting

(71) Applicant: Insulation Components, Inc., Mishawaka, IN (US)

(72) Inventors: Kevin Duane Lockwood, Bremen, IN (US); David Xavier Vandygriff, Osceola, IN (US); Kevin Robert Marvel, Waxhaw, NC (US)

(73) Assignee: Insulation Components, Inc., Mishawaka, IN (US)

(21) Appl. No.: 19/434,129

(22) Filed: Dec. 29, 2025

Related U.S. Application Data
(60) Provisional application No. 63/739,166, filed on Dec. 27, 2024.

(51) Int. Cl. F16L 59/135

(52) U.S. Cl. CPC F16L 59/135

(57) ABSTRACT

An insulated pipe hanger support made from sheet metal is formed into an arcuate shape with an inside surface and an oppositely located outside surface. Centrally located aperture and slots allow for different mounting options. The aperture allows for a bolt, screw, rivet, or other fastener to secure the support to another structure. The slots are located on either side of the aperture and allow for a strap, cable tie, or other device to wrap around to secure the support to another structure, such as a clevis hanger, channel, or other device. The support may have flared ends and/or ribs for additional rigidity, handling convenience, and/or to protect the pipe insulation from damage.

### CROSS REFERENCE TO RELATED APPLICATIONS

This application claims the benefit of Provisional Application Serial No.

63/739,166, filed Dec. 27, 2024, the disclosure of which is incorporated by reference.

### BACKGROUND OF THE INVENTION

The present disclosure relates to pipe hangers and saddles/shields for supporting pipes and other tubing. The shields are usually made from stamped sheet metal and formed to fit the outside diameter of the pipe. The shields may also contain ribs or other stiffening elements to help maintain the shield's shape and provide centering, location, and retention features. The pipes are frequently covered in insulation and secured to the building or other structure at regular intervals, and the shield is placed over the insulation between the pipe and the attachment point to prevent damage to the insulation, vapor barrier, or other cladding. It also spreads out the forces needed to support the pipe. However, due to vibration, thermal expansion/contraction, structural movement, or seismic activity, the shield can migrate away from the attachment point, leaving the pipe improperly supported and risking injury to a bystander from a falling shield. Some have attempted to solve this problem by adding a feature to secure the shield, such as what is disclosed in US 11,073,230 or US 11,118,721. However, these designs still allow movement around the hanger or pipe, potentially allowing direct contact between the support and insulation. Others secure the saddles/shields to the hanger with welding, but that process requires additional equipment and expertise to operate. An improved device is needed.

### SUMMARY OF THE INVENTION

The present disclosure describes a saddle/shield having multiple mounting and retention options, using a band or strap through transverse slits or a carriage bolt or other fastener through a centrally-located fastener aperture. The pipe shield comprises an arcuate member having a concave surface and an oppositely located convex surface. The arcuate member has parallel lateral edges and arcuate transverse edges, along with chamfer edges connecting each of the transverse edges to each of the lateral edges. The arcuate member has an aperture extending therethrough and the aperture is located equidistant from the lateral edges and the transverse edges. The arcuate member has a pair of elongate slots extending therethrough flanking the aperture and equally spaced therefrom. The elongate slots are parallel to the transverse edges and equally spaced from the lateral edges. One of the slots is a first slot and the other slot is a second slot. The pipe shield can be attached to a structure either through the slots or the aperture.

If the structure is an elongate member having at least a portion being equal to or more narrow than a distance between the first and second slots, the pipe shield is attached using a shape retaining deformable elongate strip. The strip extends through the first and second slots, with a portion of the strip located between the first and second slots overlaying a portion of the concave surface.

If the structure has a fastening aperture, a fastener is located in the aperture and the fastening aperture. The fastener has a head portion in contact with the concave surface and a threaded shaft portion extending through the fastening aperture.

### BRIEF DESCRIPTION OF THE DRAWINGS

FIG. 1 is an isometric view of several optional embodiments of a pipe shield as affixed to a length of structural channel;

FIG. 2 is an isometric view of a pipe shield affixed to the channel with banding;

FIG. 3 is an isometric view of a pipe shield affixed to the channel using a fastener;

FIG. 4 is an isometric view of a pipe shield;

FIG. 5 is an isometric section view 5-5 of the pipe shield in FIG. 2;

FIG. 6 is a top isometric view of the pipe shield as affixed to a clevis hanger;

FIG. 7 is a bottom isometric view of the pipe shield in FIG. 6

FIG. 8 is a top isometric view of the pipe shield as affixed to an I-beam;

FIG. 9 is an isometric section view 9-9 of the pipe shield; in FIG. 8.

### DESCRIPTION OF THE PREFERRED EMBODIMENT

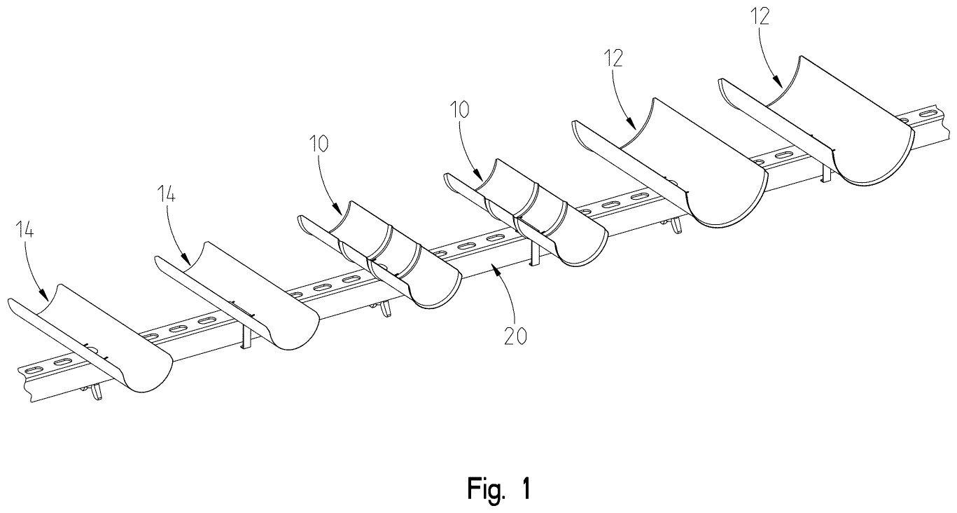

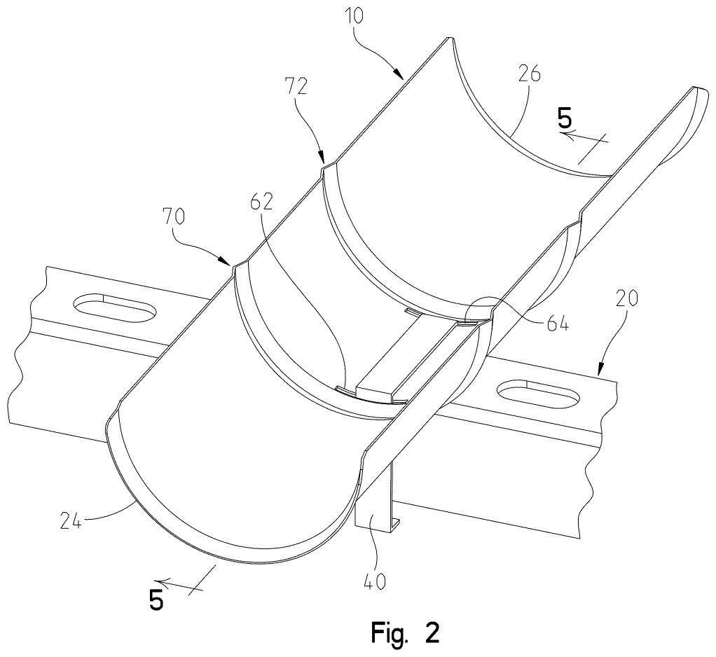

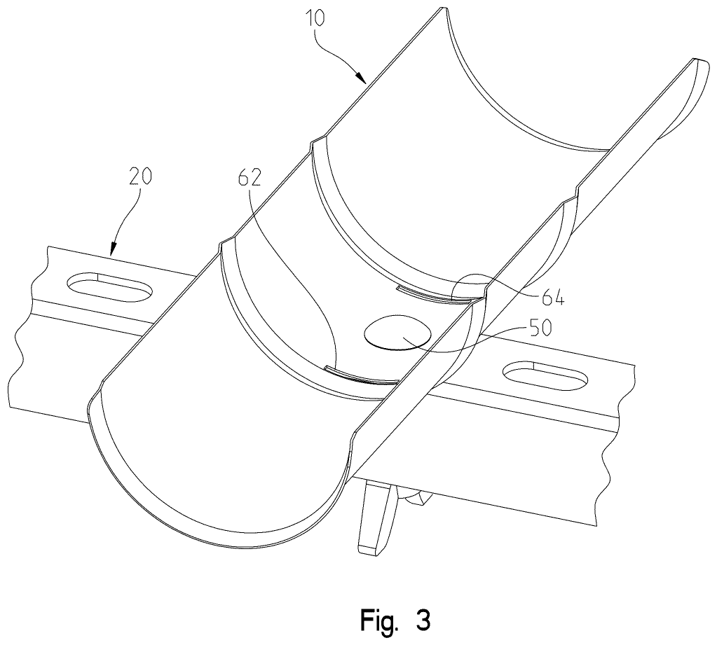

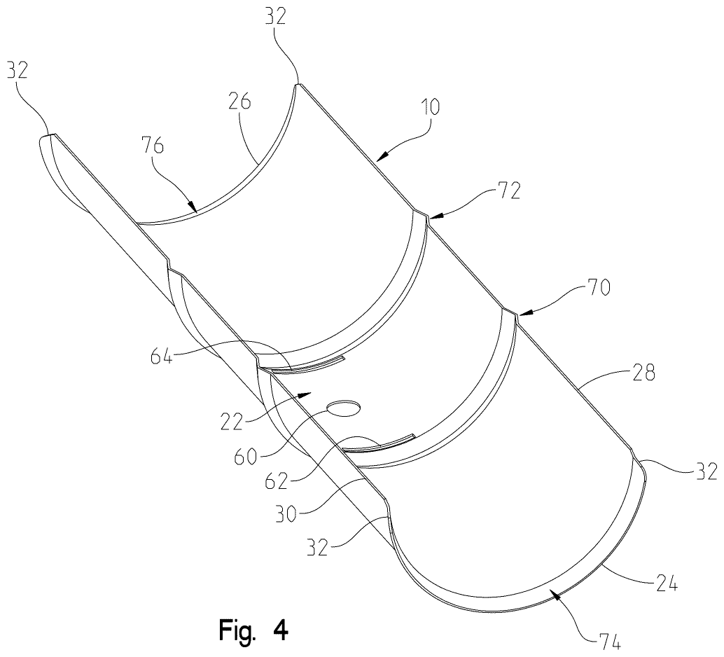

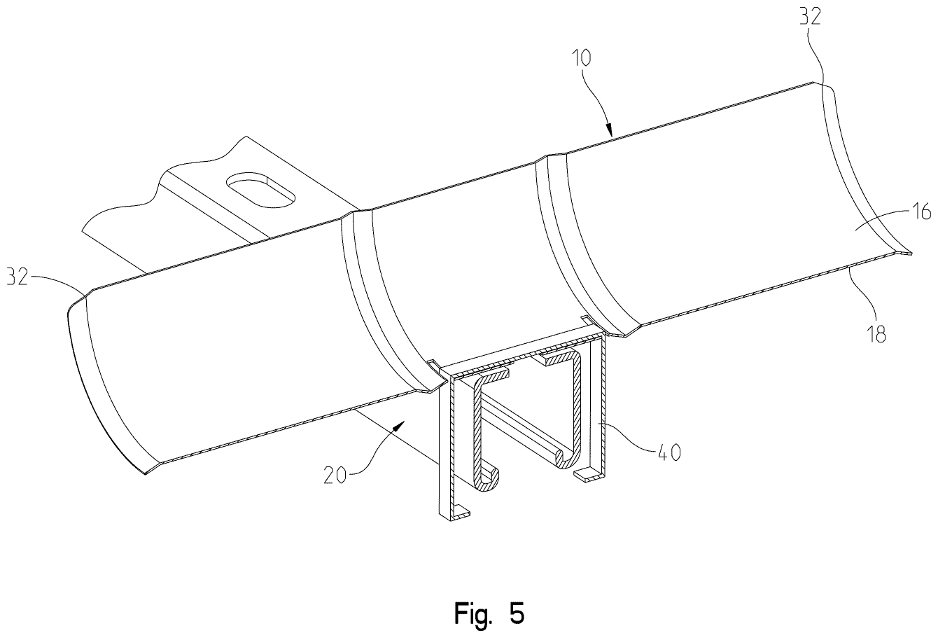

Pipe shields 10, 12, 14 are shown in FIG. 1 as attached to a structural channel 20. Shield 10 is shown individually in FIG. 4. The shield is used to support an insulated pipe or other cylindrical structure by distributing or spreading out the contact pressure where the pipe and channel 20 meet. The shield 10, 12, 14 is formed from sheet metal that is punched, cut, and rolled to form an arcuate portion of a cylinder. The shield 10, 12, 14 has a concave inside surface 16 and a convex outside surface 18, shown in FIG. 5. As can be seen in FIGS. 2 and 3 (and described in greater detail below), the pipe shield 10 can be secured to the channel 20 or other structural shape in more than one fashion. In addition, the pipe shield has different embodiments that may or may not contain ribs or flared ends.

Regardless of the presence of ribs or flared ends, the shield will contain a centrally located flexible attachment feature 22. The shield 10 shown in FIG. 4 shows the flexible attachment 22, which can be used with a shape-retaining strap 40 (FIG. 2) or fastener such as a carriage bolt 50 (FIG. 3). The shield 10 has a length as defined by the distance between transverse edges 24, 26, and a width as defined by the distance between lateral edges 28, 30. The shield 10 has a chamfer 32 at each corner where transverse edges 24, 26 meet lateral edges 28, 30. As shown, the chamfer 32 is at or substantially at a 30 degree angle from its corresponding lateral edge 28, 30, but other angles, such as 45 degrees or any other angle between 0 and 90 degrees are contemplated. For the purposes of this disclosure, substantially is defined as within 10 degrees of the desired angle of the chamfer 32.

The flexible attachment 22 comprises a central aperture 60 that is located equidistant from the transverse edges 24, 26 and lateral edges 28, 30. The central aperture 60 extends through the thickness of the shield and is shown as a circle, but it can also be a square to mate with the head of a carriage bolt 50. Flanking the central aperture 60 are elongate slots 62, 64 that are equally spaced from the central aperture 60 and lateral edges 28, 30. The elongate slots 62, 64 are parallel to the transverse edges 24, 26 and also extend through the thickness of the shield. The slots 62, 64 are spaced apart at least as wide as the anticipated width of the channel 20 or other structural support. The elongate slots 62, 64 have a narrow width and extended arcuate length to receive the shape-retaining strap 40 as shown in FIGS. 2 and 5. As shown, the slots 62, 64 are long and narrow, with the arcuate length being roughly 10 times the width. Other aspect ratios are contemplated, provided they can receive the strap 40 or equivalent. As installed, the strap 40 extends between the elongate slots 62, 64 on the inside concave surface 16, where it also covers the central aperture 60.

The shield 10 is shown in FIGS. 2-5 with stiffening ribs 70, 72 and flared ends 74, 76. The shield 12 shown in FIG. 1 only has flared ends 74, 76, and shield 14 is free of flared ends and stiffening ribs. For shield 14, there is only one radius. For shield 12, the flared ends 74, 76 are at a larger radius than the rest of the shield. For shield 10, the stiffening ribs 70, 72 and/or flared ends 74, 76 are at a larger radius than the rest of the shield. The stiffening ribs 70, 72 are parallel to the elongate slots 62, 64 and extend from one lateral edge 28 to the other lateral edge 30. When the stiffening ribs 70, 72 are present, they are equally spaced from the central aperture 60 and at a greater distance than the slots 62, 64. The flared ends 74, 76 are either a formed radius or angled portion where at least a portion of the transverse edge is at a larger radius than the rest of the arcuate portion of a cylinder. Due to the length of the chamfers 32, the flared ends 74, 76 do not extend to the lateral edges 28, 30 in the embodiments shown herein.

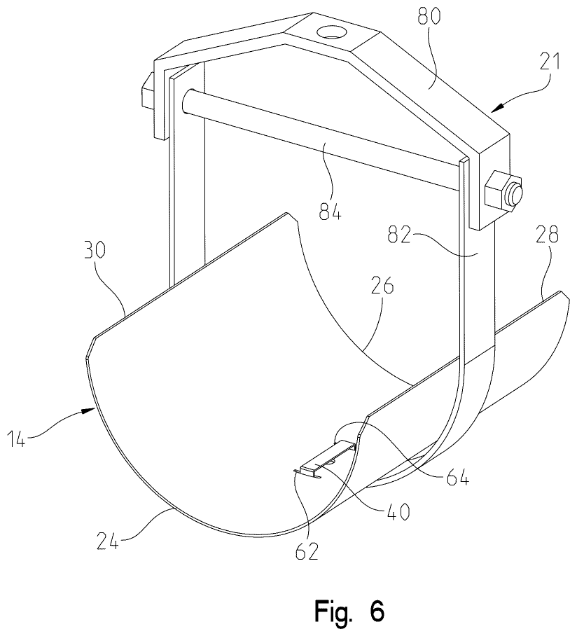

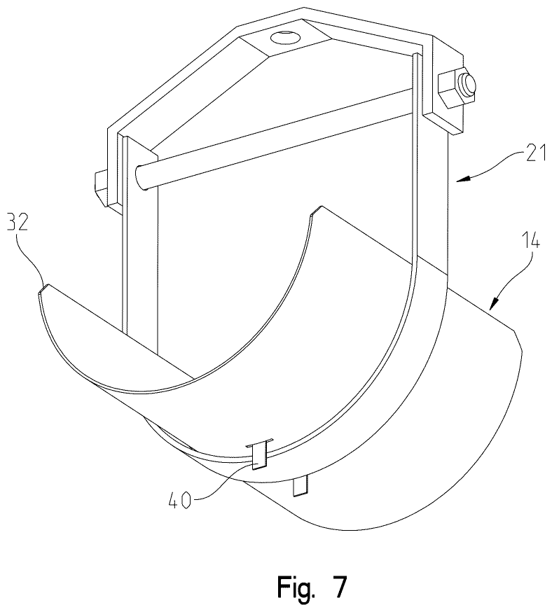

An alternate installation is shown in FIGS. 6 and 7 on a clevis hanger 21. The clevis hanger 21 is typically installed to a building or structure using a c-clamp and threaded rod that extends between the c-clamp and the hanger 21. The hanger has an upper portion 80 that is secured to a U-shaped lower portion 82 with a bolt 84. The lower portion 82 is an elongate strip of material (typically metal) that has is bent to have a radius that closely matches the outside diameter of the pipe (not shown) or shield. The shield 14 in this alternate installation is only an example without ribs or flared ends; shield 10 or shield 12 is also fully compatible with a clevis-style hanger. The shield can be attached using the shape-retaining strap 40 by bending the ends of the strap over the radiused portion of the lower portion.

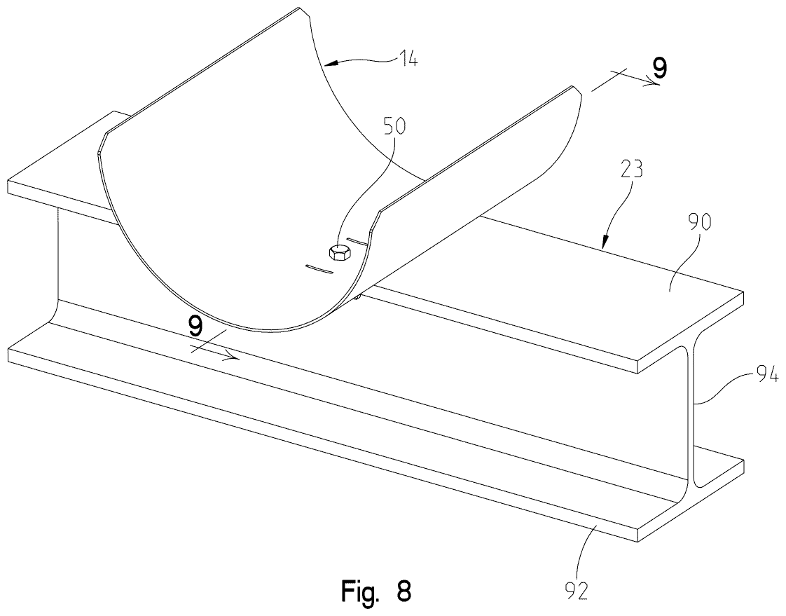

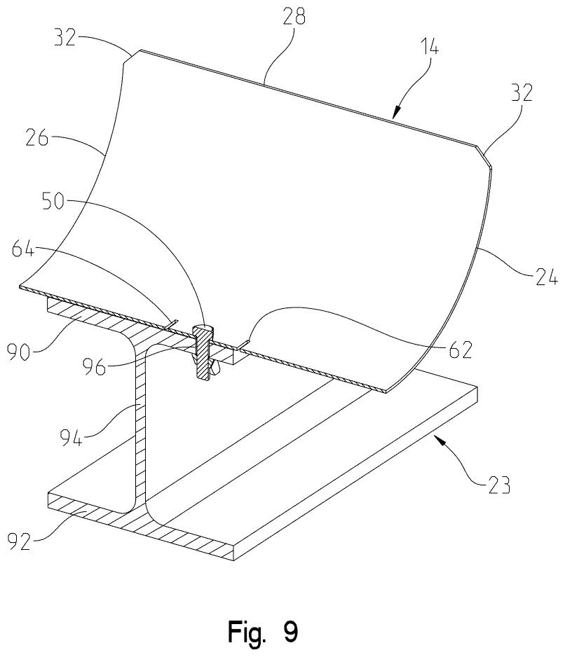

Another alternate installation is shown in FIGS. 8-9 on an I-beam 23. The I-beam 23 has an upper wall 90, a lower wall 92, and a connecting wall 94. The shield 14 in this alternate installation is only an example without ribs or flared ends; shield 10 or shield 12 is also fully compatible with mounting on structural members such as the I-beam 23 as shown. In this installation, a hole 96 is punched or drilled through a portion of the I-beam and the bolt 50 is placed through the central aperture 60 and aligned with the hole in the I-beam.

To manufacture the shield 10, 12, 16, a strip of flat sheet metal having a width defined by the distance between transverse edges 24, 26 is notched to form the chamfers 32. After the notching is complete, the flat sheet metal proceeds to a metal shear that forms flat blanks with lateral edges 28, 30. Next, the blanks pass through rollers that are one of three varieties. One variety is flat and is used to form shield 14, without flared ends or stiffening ribs. Another variety of rollers has flare features that also add the flared ends 74, 76 on shield 12. Lastly, the third variety of rollers has flare features and rib features that is used to form shield 10. The curvature and optional flared ends and/or ribs are generated at the same time with a single pass through the rollers.

To install the shield 10, 12, 14, the user can either secure it using the central aperture 60 or the slots 62, 64. To install the shield using the central aperture 60, the user places the bolt 50 through the central aperture 60 and any structural support (such as the channel 20 or I-beam 23). The user then can secure the bolt 50, if desired. To install the shield 10, 12, 14 using the slots 62, 64, the user starts with a length of the strap 40 in a flat state, and passes it through one of the slots 62, across the inside concave surface 16, and through the other slot 64. Next, the user positions the shield and strap over the structural support (such as the channel 20 or clevis 21), and then bends the free ends of the strap 40 over and around the support. It is contemplated that the user can use materials other than the strap to secure the shield using the slots 62, 64. These include cable ties, rope, wire, or other materials that can pass through the slots and be secured to itself, pipe support, or other materials.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A pipe shield comprising:
an arcuate member having a concave surface and an oppositely located convex surface, said arcuate member having parallel lateral edges and arcuate transverse edges, said arcuate member having chamfer edges connecting each said transverse edge to each said lateral edge;
said arcuate member having an aperture extending therethrough, said aperture located equidistant from said lateral edges and said transverse edges; and
said arcuate member having a pair of elongate slots extending therethrough, said slots flanking said aperture and equally spaced therefrom, said elongate slots are parallel to said transverse edges and equally spaced from said lateral edges, one of said slots is a first slot and another of said slots is a second slot.

2. The pipe shield in claim 1, further comprising a structure, said structure is an elongate member having at least a portion being equal to or more narrow than a distance between said first slot and said second slot.

3. The pipe shield in claim 2, further comprising a shape retaining deformable elongate strip, said strip extending through said first slot and said second slot, a portion of said strip located between said first and second slots overlaying said aperture and a portion of said concave surface.

4. The pipe shield in claim 1, further comprising a structure having a fastening aperture.

5. The pipe shield in claim 4, further comprising a fastener located in said aperture and said fastening aperture, said fastener having a head portion in contact with said concave surface and a threaded shaft portion extending beyond said convex surface.

6. The pipe shield in claim 1, wherein said arcuate member has ribs extending from one of said lateral edges to another of said lateral edges, said elongate slots and said aperture located between said ribs.

7. The pipe shield in claim 1, wherein said arcuate member has a flare, said flare is located on the entirety of said arcuate transverse edges and extends towards said slots, said flare extending partially into said chamfer edges and said flare is clear of said parallel lateral edges.

8. The pipe shield in claim 1, wherein said chamfer is at or substantially at a 30 degree angle from its corresponding said lateral edge.

9. A pipe shield for supporting an insulated pipe and affixed to a structure, said pipe shield comprising:
said structure having a fastening aperture;
an arcuate member having a concave surface and an oppositely located convex surface, said arcuate member having parallel lateral edges and arcuate transverse edges, said arcuate member having chamfer edges between said transverse and lateral edges;
said arcuate member having an aperture extending therethrough, said aperture located equidistant from said lateral and transverse edges;
said arcuate member having a pair of elongate slots extending therethrough, said slots flanking said aperture and equally spaced therefrom, said elongate slots are parallel to said transverse edges and equally spaced from said lateral edges, one of said slots is a first slot and another of said slots is a second slot;
a fastener located in said aperture, said fastener having a head portion and a threaded shaft portion; and
said fastener extending through said aperture in said arcuate member and said head portion in contact with said concave surface, said threaded shaft portion secured to said fastening aperture in said structure.

10. The pipe shield in claim 9, wherein said structure is an I-beam.

11. The pipe shield in claim 9, wherein said arcuate member has ribs extending from one of said lateral edges to another of said lateral edges, said elongate slots and said aperture located between said ribs.

12. The pipe shield in claim 9, wherein said arcuate member has a flare, said flare is located on the entirety of said arcuate transverse edges and extends towards said slots, said flare extending partially into said chamfer edges and said flare is clear of said parallel lateral edges.

13. The pipe shield in claim 9, wherein said chamfer is at or substantially at a 30 degree angle from its corresponding said lateral edge.

14. A pipe shield for supporting an insulated pipe and affixed to a structure, said pipe shield comprising:
an arcuate member having a concave surface and an oppositely located convex surface, said arcuate member having parallel lateral edges and arcuate transverse edges, said arcuate member having chamfer edges between said transverse and lateral edges;
said arcuate member having an aperture extending therethrough, said aperture located equidistant from said lateral and transverse edges;
said arcuate member having a pair of elongate slots extending therethrough, said slots flanking said aperture and equally spaced therefrom, said elongate slots are parallel to said transverse edges and equally spaced from said lateral edges, one of said slots is a first slot and another of said slots is a second slot;
said structure is an elongate member having at least a portion being equal to or more narrow than a distance between said first slot and said second slot;
a shape retaining deformable elongate strip, said strip extending through said first slot and said second slot, a portion of said strip located between said first and second slots overlaying said aperture and a portion of said concave surface; and
said elongate strip extending beyond said convex surface on either side of said portion of said structure.

15. The pipe shield in claim 14, wherein said structure is a clevis hanger having a U-shaped lower portion, said shape retaining deformable elongate strip extending on either side of said U-shaped lower portion.

16. The pipe shield in claim 14, wherein said structure is a structural channel, said shape retaining deformable elongate strip partially surrounding said structural channel.

17. The pipe shield in claim 14, wherein said arcuate member has ribs extending from one of said lateral edges to another of said lateral edges, said elongate slots and said aperture located between said ribs.

18. The pipe shield in claim 14, wherein said arcuate member has a flare, said flare is located on the entirety of said arcuate transverse edges and extends towards said slots, said flare extending partially into said chamfer edges and said flare is clear of said parallel lateral edges.

19. The pipe shield in claim 14, wherein said chamfer is at or substantially at a 30 degree angle from its corresponding said lateral edge.
